(19) United States
(12) Patent Application Publication
(10) Pub. No.: US 2017/0153179 A1
(43) Pub. Date: Jun. 1, 2017

(54) RANDOM LASER DETECTOR

(71) Applicant: KING'S COLLEGE LONDON, London (GB)

(72) Inventors: Riccardo SAPIENZA, London (GB); Michele GAIO, London (GB); Soraya CARLOS-CAIXEIRO, London (GB)

(21) Appl. No.: 15/319,300

(22) PCT Filed: Jun. 29, 2015
(86) PCT No.: PCT/GB2015/051900

§ 371 Date: Dec. 15, 2016

(30) Foreign Application Priority Data
Jun. 30, 2014 (GB) 1411568.7

(51) Int. Cl. G01N 21/63; G01N 21/77

(52) U.S. Cl. CPC G01N 21/636; G01N 21/77; G01N 2021/7769

(57) ABSTRACT

The present disclosure is directed toward a target detector, a method of detecting a change in a target, target monitoring apparatus, and a method of monitoring a target. For example, a target detector includes a structure having a gain medium comprising a plurality of disordered nanostructure features and a target-sensitive material. In addition, for instance, the structure, when pumped, supports random lasing and exhibits a change in the gain of the gain medium and the random lasing in response to a change in the target. Accordingly, it is possible to use an appropriately fabricated random laser material as a detector or sensor for a target. In particular, example embodiments perform sensing operations by utilizing the properties of random lasing. That target may, for example, comprise a change in a physical parameter of an environment adjacent, surrounding or permeating the random laser material.

### FIELD OF THE INVENTION

The present invention relates to a target detector; a method of detecting a change in a target, target monitoring apparatus and a method of monitoring a target.

### BACKGROUND

Random lasing in scattering disordered gain materials is known. Typically a random laser gain medium includes a plurality of features which operate to scatter incident radiation, for example, light photons, in such a way that they are diffused though the gain medium and travel a distance through that gain medium which is sufficient to obtain random lasing.

It will be understood that a typical random laser has no optical cavity in the sense of a conventional laser and that the resulting random lasing typically occurs in all directions.

The present invention recognises that it may be possible to use the properties of random lasers as a means to detect or monitor a target.

### SUMMARY

Accordingly, a first aspect provides a target detector comprising: a structure comprising: a gain medium comprising a plurality of disordered scattering nanostructure features and a target-sensitive material; the structure being configured, when pumped, to support random lasing and to exhibit a change in the gain of the gain medium and the random lasing in response to a change in the target.

The principle of random lasing is the same that of conventional lasing but structures which can provide random lasing have no need for carefully aligned optical elements. In a random lasing system, a disordered structure of scatterers may operate to “fold” optical paths inside the structure by means of multiple scattering. Ensuring the structure is formed from a material which can operate as a gain medium, and provide a net optical gain, allows the structure to provide amplification to trigger lasing. A typical random laser structure comprises a substantially opaque medium in which laser light is generated by flowing and scattering through it by interaction with the gain medium. Emission occurs in all directions at specific light wavelengths. Those wavelengths can be chosen by designing an appropriate disordered structure.

The first aspect recognises that it is possible to use an appropriately fabricated random laser material as a detector or sensor for a target. In particular, the first aspect recognises that it is possible to perform sensing operations by utilizing the properties of random lasing. That target may, for example, comprise a change in a physical parameter of an environment adjacent, surrounding or permeating the random laser material. That physical environmental target may, for example, comprise: temperature, pH or similar. The target may, for example, comprise a change in, or the appearance of, a substance present in an environment adjacent, surrounding or permeating the random laser material. In such a case, the random laser material may operate as a target-substance or target-material monitor or detector. In some embodiments, the target substance or target material may result in chemical bonding or a chemical reaction with said target-sensitive material to cause a change to the gain of the gain medium and thus cause a detectable change to the random lasing of the structure comprising the gain medium.

The first aspect recognises that in order to operate as a lasing material a pumped, or stimulated, a gain medium must meet the lasing threshold. That is to say, to exhibit random lasing, the gain medium must operate in conditions in which stimulated emission dominates spontaneous emission. The gain medium must, for example, be large enough to meet the lasing threshold. In the case of a random laser, stimulated emission is related to the expression: egL where: g comprises an indication of effective gain of the material forming a random laser structure and L comprises an indication of a typical effective length travelled by a photon within the material forming a random laser structure (equivalent to the cavity length of a conventional laser).

The first aspect recognises that although it may be possible to alter the effective length (L) that a photon travels within a random laser structure, an alternative approach can be implemented in which the effective gain of the random laser structure is altered. In order to change the effective length L, for example, in a random laser structure comprising: a gain medium in which a number of substantially spherical scatterers are provided, it may be possible to alter the effective diameter or refractive index of those scatterers. A detector in accordance with the first aspect seeks to change the effective molecular properties of a random laser structure in the presence/absence or change in a target by including a target sensitive material in the gain material forming the random laser structure, thus changing the gain of that laser structure. The first aspect may be of use in applications where a plurality of laser, or fluorescence dye, binding sites are provided within the laser structure as the target sensitive material, and said target comprises: the laser or fluorescence dye. Accordingly, the relevant dye may be used to detect, sense or monitor a chemical or other physical process occurring in the ambient environment occurring around, adjacent or within a random laser structure.

In other words, aspects and embodiments may provide an arrangement in which the effective gain of the random laser structure is altered, rather than the macroscopic refractive index of the laser structure. Aspects and embodiments may provide a detector according to which the refractive index of the random laser structure remains unchanged in the presence or absence of the target.

The first aspect may provide a target detector, sensor or monitoring device. That device may comprise: a structure comprising: a gain medium comprising a plurality of disordered nanostructure features and a target-sensitive material. In some arrangements the gain material itself may comprise a target sensitive material. The device structure may be configured, when pumped, to support random lasing. In other words, the gain medium is arranged so that it is excited on application of appropriate pumping radiation. The device structure may be configured to exhibit a change in the gain of the gain medium in response to a change in the target. The device structure may be configured to exhibit a change in the random lasing in response to a change in the target.

In one embodiment, the structure comprises: a substantially porous structure. Accordingly, by providing a porous structure, through which a gas, liquid or other fluid may pass, the ambient environment in the region of the target detector can permeate the structure. Such an arrangement allows access to a greater surface area of the structure for the purposes of target detection, compared to a non-porous structure. It will be appreciated that provision of a larger detection surface can allow for a more sensitive target detector. Such embodiments recognise that the open architecture of a porous disordered material may provide ideal scaffolding for integration of, for example, biomolecules and/or living cells.

In one embodiment, the structure comprises: a biocompatible gain material. In one embodiment, the structure comprises a biopolymer. Accordingly, such a structure may be used as a biodetector or biosensor. Such an embodiment recognises that a random lasing structure in accordance with the first aspect may be useful in the biological field. It will be appreciated that conventional lasing and bio-lasing usually requires periodic structures, carefully aligned mirrors and geometries which may not be compatible with biological systems. Such systems are, by nature, are complex and disordered. A conventional laser device cannot conform to, for example, human skin, which may be stretched, wetted and/or heated. The first aspect recognizes that use of a random lasing system which uses highly disordered materials to obtain laser action and optical gain may be constructed such that it has a naturally biocompatible form. Accordingly, in one embodiment, the detector may comprise a biosensor. Embodiments recognize that it is possible to construct a bio-compatible random laser with a disordered nanostructure which can be used as a new generation biosensor.

In one embodiment, the medium comprises: a matrix structure and the target sensitive material is dispersed within the matrix. Formation of a detector structure from a material which is matrix-like allows that material to be robust in nature and provides locations within the matrix in which it is possible to locate the target sensitive material. In one embodiment, the gain medium structure comprises: a polymeric material, and the target sensitive material is dispersed within the polymeric material. Such embodiments recognise that if a conventional laser is modified, stretched or flexed, the alignment and/or periodicity and therefore the optical properties are lost. In comparison, a random laser structure which supports random lasing can overcome the geometrical limitation of conventional lasing whilst being robust against any bulk/macro shape change. Construction of the random lasing gain material from a matrix or polymeric material allows an inherent degree of flexibility within the component material itself, and allows for maintenance of a general structure which is capable of random lasing. As a result, some embodiments may allow for construction of a detector which may be directly integrated, or integral to, a deformable surface or solid, fluid or gas. Such a surface, solid, or fluid may, for example, comprise a biological surface, solid or fluid.

In one embodiment, the structure comprises: a gain material. According to embodiments, the gain material may comprise: a protein, for example, silk or albumen; a polysaccharide, for example, chitosan; a colloid or nanocrystal, for example, cellulose. For each possible gain material and target combination forming a structure it is possible to predict when lasing may occur.

In one embodiment, the gain medium comprises: at least one of: silk or cellulose. Accordingly, it may be possible to form the detector structure from appropriately chosen silk and/or cellulose. A silk biosensor may offer some advantages in biological applications since silk has been approved for use in humans. A silk structure may, after use, be biodegradable and can processed by, for example, the human body, leaving no trace.

In one embodiment, the nanostructure features comprise: substantially spherical volumes having a different refractive index to material surrounding those substantially spherical volumes. In one embodiment, the nanostructure features comprise: volumes formed between neighbouring substantially spherical volumes of a material, those volumes having a different refractive index to that material. Accordingly, it will be appreciated that various structures may be formed to have random lasing properties and that a structure may be formed with a particular application in mind, or with particular lasing properties in mind. The gain material of a random laser typically comprises a disordered lattice-like structure in which changes in refractive index within the structure provide scattering of incident radiation. An appropriate structure may, for example, comprise substantially spherical “voids” within a structure, or the inverse thereof. The “voids” may comprise an air-filled space. The air-filled space may fill, as a result of the porous nature of some structures, with fluid or similar surrounding the detector structure. Provided that the voids can still operate as random scatterers, the random lasing ability of the structure may be maintained. In one embodiment, the structure of the detector may comprise an all-silk inverse photonic glass. It will be appreciated that the scattering nanostructure features may comprise features having any appropriate geometrical shape. Scattering nanofeatures or nanostructures act to scatter light within the gain medium and those structures may comprise, for example, particles, or voids and may have a size comparable with the wavelength of light of interest.

In one embodiment, the target-sensitive material comprises: a material configured to have a variation of net optical gain in the presence of said target. In one embodiment, the target-sensitive material comprises a dye molecule configured to bind with the target. Such embodiments recognize that, for example, sensing of biological activity is often done by fluorescence. Stimulated emission has been almost completely neglected in relation to biological applications. Sensing or detecting by means of monitoring random lasing within a structure can harness the amplifying power of stimulated emission, which is fundamentally different from that of fluorescence. Random laser detection techniques can be used to either complement or outperform conventional fluorescence-based detection in, for example, biological applications.

One advantage of laser-based detection is the increased signal-to-noise ratio, which results in an ability to discern otherwise hard-to-distinguish small signals resulting from biochemical interactions or biological processes of interest. Random laser detectors also may be configured such that they have an intrinsic nonlinear response, which may be very large for small changes in the sensing element and therefore may allows for easy discrimination of the presence of a target.

In one embodiment, the detector comprises: a structure having a minimum bulk dimension selected to maintain a minimum scattering pathlength. It will be appreciated that bulk detector dimensions are related to the relationship e^{gL} outlined above. As long as the scattering induced by the scattering features and the general dimensions of the structure are such that they allow incident radiation to be subject to an effective scattering length which meets lasing threshold requirements (given the gain of the detecting random sensor structure), then the detector may operate as a random lasing structure. In one embodiment, the detector comprises: a structure having bulk dimensions of between 10 to 100 micrometres. Accordingly, a target detecting lasing structure may be formed which is smaller than a conventional laser arrangement. In particular, the dimensions of a random laser detector in accordance with the first aspect may allow for introduction of the random lasting detector into a fluid, for example, water to be ingested by a patient, or directly into a biological fluid, for example, blood or similar. The detector may, for example, be formed as a powder or similar, each particle of which may be operable to act as a detector in accordance with the first aspect. Furthermore, such particles may be formed in accordance with an envisaged application. For example, detector particles may comprise rods, spheres, cones, blocks, slabs or similar.

A second aspect provides: a method of detecting a target comprising: providing a structure comprising: a gain medium comprising a plurality of disordered nanostructure features and a target sensitive material; configuring the structure such that, when pumped, random lasing is supported and such that a change in the gain of the gain medium and the random lasing is exhibited in response to a change in the target.

In one embodiment, the structure comprises: a substantially porous structure.

In one embodiment, the structure comprises: a biocompatible gain material.

In one embodiment, the medium comprises: a matrix structure and the target sensitive material is dispersed within the matrix.

In one embodiment, the gain medium structure comprises: a polymeric material, and the target sensitive material is dispersed within the polymeric material.

In one embodiment, the gain medium comprises: at least one of: silk or cellulose.

In one embodiment, the nanostructure features comprise: substantially spherical volumes having a different refractive index to material surrounding those substantially spherical volumes.

In one embodiment, the nanostructure features comprise: volumes formed between neighbouring substantially spherical volumes of a material, those volumes having a different refractive index to that material.

In one embodiment, the target-sensitive material comprises: a material configured to have a variation in net optical gain in the presence of said target.

In one embodiment, the target-sensitive material comprises a dye molecule configured to bind with the target.

In one embodiment, the detector comprises: a structure having a minimum bulk dimension selected to maintain a minimum scattering length.

In one embodiment, the detector comprises: a structure having bulk dimensions of between 10 to 100 micrometres.

A third aspect provides target monitoring apparatus comprising: a random laser pump, configured to pump a detector according to the first aspect; and a probe configured to monitor response of the target detector to said pumping. Accordingly, in order to be used as a detector, the target detector may be used in conjunction with apparatus to monitor the response of the detector to a target being monitored. In order to randomly lase, the target detector structure is pumped. That pumping can allow the random laser structure to randomly lase, just as a conventional laser is pumped to allow lasing. The response of the detector to the pumping and to the presence or absence or change in the target is monitored. That monitoring may comprise providing a suitable device operable to scan the frequency (or wavelength) response or energy response of the random lasing induced in the detector structure in order to determine a change in the target, if any. The probe may be configured to detect radiation, for example, light, emitted by the random laser structure such that observation of changes in that emission is possible.

In one embodiment, the probe is configured to monitor at least one of: wavelength response or energy response of the target detector to the pumping. Accordingly, as the gain of the gain material changes in the presence or absence of the target, the gain curve of the detector structure alters and that altering can be monitored.

In one embodiment, the pumping radiation has an energy selected to prevent damage to biological tissue. Accordingly, by appropriate selection of the detector structure, target sensitive material and pumping radiation, a random lasing target detector may be provided which is suited to use when monitoring biological tissue. Use of high energy pumping radiation may cause heating of tissue or otherwise damage tissue.

A fourth aspect provides a method of monitoring a target comprising: providing a random laser pump, and configuring pump to pump a target detector according to the first aspect; providing a probe and configuring the probe to monitor response of the detector to the pumping.

In one embodiment, the method comprises: configuring the probe to monitor at least one of: wavelength response or energy response of the target detector to the pumping.

In one embodiment, the method comprises: selecting the pumping radiation to have an energy which prevents damage to biological tissue.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION OF THE DRAWINGS

Embodiments of the present invention will now be described further, with reference to the accompanying drawings, in which:

FIGS. 1a to 1c illustrate schematically the main stages of fabrication of a target detector according to one arrangement;

FIGS. 2a and 2b illustrate graphically characterisation of transport properties of a target detector such as that shown in FIG. 1; and

FIGS. 3a and 3b illustrate graphically lasing properties of one possible silk random laser structure.

### DESCRIPTION OF THE EMBODIMENTS

Before discussing the embodiments in any more detail, first an overview will be provided. One embodiment of aspects described herein uses silk to create a biolasing device for measuring changes in the local properties of biological systems. The advantages of natural silk include that it is: transparent, can manipulate light while at the same time being: biocompatible and biodegradable. Random lasing may offer a bridge between lasing science and biological materials by means of the common features of disorder and complex geometry. Aspects and embodiments recognise that it is possible to design disordered nanostructures, for example, silk nanostructures, to achieve, control and enhance random lasing and that such structures may be constructed in a manner which is biocompatible with living tissue.

It will be appreciated that, in general, a biolaser has the potential to detect biological activity with extraordinary sensitivity, if it is possible to monitor the changes in a system associated with laser amplification. That sensitivity associated with laser action is fundamentally different to the properties of fluorescence, which is typically used in the imaging of biological systems and processes.

Biocompatible, for example, silk or cellulose, lasing devices offer a new class of light source. Such lasing devices are highly nonlinear and thus may provide a useful tool or sensor to measure changes in local properties of, for example, biological systems. In particular, some embodiments may, for example, provide a random lasing structure operable to detect hydrogen peroxide. Hydrogen peroxide is involved in oxidative stress, is of relevance in biological systems to, for example, monitor cell ageing or indicators of neurodegenerative diseases such as Alzheimer's and Parkinson's. Hydrogen peroxide is, however, difficult to detect using fluorescence techniques.

Aspects and embodiments described achieve, control and enhance random-lasing in biocompatible materials, for example, silk. Aspects and embodiments may exploit the intrinsic complex geometry of silk, cellulose, or other similar materials.

Lasing has been almost completely neglected as a means to monitor bio-applications. Inserting a laser into a biosystem, such as a cell or tissue, to achieve a stand-alone laser is not attractive since conventional lasing and biolasing require precise and bulky geometries which are typically incompatible with biological systems, which are typically complex and disordered, built on mutable geometries and mechanical forces.

It will be appreciated that a random lasing structure is typically not influenced by overall shape of that material but instead relies on internal porosity and the optical properties resulting from internal nanostructures. As a result, random lasing may provide a lasing system which has a biocompatible form since those structures are typically highly disordered materials to obtain laser action. In a random laser structure, a disordered matrix typically operates to scatter incident light and thus “fold” light paths inside the structure by use of multiple scattering from nanostructures. That scattering acts to replace the mirrors of a conventional laser. The principle of operation of a random laser structure is the same as that of conventional lasing but without the need for carefully aligned optical elements.

A typical random laser structure takes the form of an opaque medium in which laser light is generated by light flowing and scattering through that medium. A random laser structure may be constructed to have an intrinsic porosity at the nano- and micro-scale. That porous structure, necessary to trap light by scattering, is also ideal for infiltration with biofluids or living cells. Such lasing devices are flexible and robust and, depending on the material used, may be suited to implantation in or on human skin or tissue. The random laser structure on a nanoscale (ie the internal structure of the laser, which operates to provide random lasing) has an inherent ability to withstand stretching, wetness and/or heat and similar.

In order to provide a random laser device which can operate as a detector, it may be necessary to ensure that the detector has biocompatible shape, and that the material constituents of a potential device can be directly compatible with living tissue.

In some arrangements described in detail below, the primary structure of the random lasing material is formed from silk fibroin, a natural protein produced by the Bombyx mori caterpillar. Silk fibroin can be nanostructured to form an appropriately designed photonic material. Silk fibroin can also support random lasing in such a constructed material. Silk is flexible, natural, economic, biocompatible and biodegradable and can be easily mass-produced. A silk random laser may provide a route to combine form (disordered shape of the material) and function (lasing emission) in one biocompatible system.

The novel optical material according to arrangements, nanostructured silk, has lasing properties which are being explored. Known lasing in silk has been limited to one-dimensional and fixed periodic structures. A random lasing approach may allow for lasing in complex geometries, such as those seen in biomaterials. One particular application for an arrangement is that of laser-based biosensing. Such new biolasing architectures have potential for use in sensing, detecting and/or monitoring applications where present fluorescent sensors may be deficient, for example, in relation to monitoring reactive oxygen species.

Since random lasing can adapt to changes in the material structure (due to, for example, stretching) it can offer an approach which may be more robust and more flexible than a standard lasing system. Some arrangements, for example, silk random lasers may be used in relation to on-skin biosensing applications. Furthermore, it will be appreciated that a silk or cellulose based biosensor could be made in all natural materials and processed with water at room temperature, therefore offering a holistic process which is clean and green. It will also be appreciated that since silk is an approved material for use in medical devices, silk lasers may be integrated inside biological tissues for bioengineering applications. Such Bioengineering applications may comprise, for example, a tool to image and sense biological properties inside the human body. Possible applications include, for example, sub-millimetre scale silk random lasing devices configured for insertion into a patient muscle and interrogated during an operation to monitor muscle health status via for example, monitoring of an oxidation stress level.

Arrangements described may provide a means to: engineer dye molecules inside a silk protein scaffold; construct a silk nanostructure material; achieve random lasing action; and use a silk nanostructure material as a novel biosensor.

In some arrangements, a nanostructured silk material can be achieved by self-assembly of nanoparticles, i.e. by letting them deposit and organize themselves into complex patterns by controlling local forces. Once the growth parameters are optimised, large nanostructured materials can be obtained effortlessly and very cheaply.

The lasing action of the silk nanostructured material can be triggered by shining intense pumping laser radiation onto the material. In order to use the material as a detector the emission of the silk material can be monitored and recorded, for example, by measuring colour and/or intensity of that emission.

A sub-millimetric random lasing material may be implanted, in some arrangements, in living tissues to become a novel bio-sensor. Detection and monitoring sensitivities of a device according to some arrangements can be established by measuring the lasing process while changing the content of the target chemical compound diffusing into the silk structure.

It will be appreciated that arrangements may provide a biocompatible lasing device which is able to measure changes in local properties of biological systems. Arrangements have potential to be highly sensitive due to the intrinsic nonlinear response and large spectral purity of random lasers.

Random lasing in silk doped inverse photonic glass as described in more detail below can provide a disordered nanostructure which is compatible with implantation or insertion into living.

In random laser arrangements described in more detail below a disordered medium replaces the standard optical cavity and operates to “fold” the optical path taken by photons by means of multiple scattering. Optical gain provides the amplification required for laser action. Compared to fluorescence-based sensors, a random lasing sensor reacts to changes in amplification, and can exploit dyes with poor fluorescence properties, allowing new sensing schemes.

Arrangement 1: Biocompatible Random Laser

Bio-Lasing

Biolasers generally have the potential to detect biological activity with high sensitivity by harnessing the amplifying power of stimulated emission. That differs fundamentally from fluorescence based techniques. Monitoring changes in laser output characteristics, such as intensity, spectrum and/or lasing threshold, may allow for underlying biochemical and biological processes to be revealed.

One advantage of laser-based detection is the increased signal-to-noise ratio, which results in an ability to discern otherwise hard-to-distinguish small signals. This can be achieved as a result of the spectral purity of a lasing signal which is easily discernible even when viewed on a noisy background. Lasers also offer an intrinsic nonlinear response, which can be very large for small changes in the sensing element, and therefore can allow for easy discrimination of the presence of a target.

Surprisingly, until now, stimulated emission has been almost completely neglected for bio purposes, with only limited applications [1]. However, in the known applications a biological material is incorporated in a lasing system.

Insertion of a laser into a biosystem, such as a cell or tissue, to achieve a stand-alone laser is not known. This may be a result of conventional lasing and biolasing requiring periodic structures [2], carefully aligned mirrors [3] and bulky geometries that are not compatible with biological systems.

Aspects, embodiments and arrangements described recognise that random lasing, using a lasing system that comprises disordered materials to obtain laser action, may naturally have a biocompatible form.

In a random lasing system, a disordered matrix folds optical paths inside a gain medium by inducing multiple scattering events in incident photons, and optical gain provides amplification to trigger lasing [4].

The principle of operation of a random laser is similar to that of conventional lasing but without the need for carefully aligned optical elements. Random laser structures may take the form of an opaque nanostructured medium in which laser light is generated by flowing and scattering through that medium. Random laser emission occurs in all directions at specific light wavelengths and can be controlled by designing the disordered medium [5].

Such lasing devices are flexible, robust, and may be implanted in biological tissue since they inherently have an ability to withstand stretching, wetness and heat etc whilst still retaining the ability to randomly lase.

Aspects, embodiments and arrangements described introduce random lasing architectures to biological sensors.

In terms of compatibility with living tissue, biocompatible soft materials that can sustain lasing have not been widely reported in literature. Two studies on all-biological lasers have reported lasing processes for a living cell in a laser cavity [3] and biopolymers [6], highlighting interest in gain media made of water-based soft matter instead of the usual crystalline condensed matter.

Materials for Bio-Lasing:

Biopolymers in general are attractive materials because they mimic the natural components of the human body. Silk fibroin, the natural protein produced by the Bombyx mori caterpillar, has been shown to have excellent optical properties, such as transparency. Such silk can also be constructed to have a nanostructure at an optical wavelength scale. The silk is also biocompatible and biodegradable [7]. Silk biopolymers have robust mechanical properties. Silk can be doped with metallic nanoparticles sustaining plasmon resonances [8], and can offer a good host for dye molecules, achieved by either dissolving the dye in silk or feeding dye to the caterpillar [9]. Nanostructured silk provides a biologically favourable microenvironment and a porous open architecture that is ideal to entrain various biological and/or chemical dopants and maintain random lasing functionality.

While a conventional lasing architecture in silk has been reported, it is restricted to a glass substrate structured with a grating [10] and practical applications, e.g. sensors on human skin, are limited by the delicate periodicity of the grating. If the laser substrate surface is modified, stretched or flexed, the periodicity and therefore the optical properties are lost.

Random lasing structures can overcome the geometrical limitation of conventional lasing, and be very robust against any bulk shape changes.

Optical Biomaterials, Random Lasing and Sensing

Arrangements may provide a random lasing system made out of silk and dye molecules. By building on the most advanced fluorescence sensing dyes, and exploiting a disordered material geometry, arrangements may provide a random lasing device made only of doped silk. In some arrangements, random lasing may change state (on/off) and/or spectral emission in dependence upon target biological activity. Arrangements thus provide a structure which provides a detector or “lasing sensor”.

Arrangements provide a free-standing flexible random lasing device, with elementary units as small as ˜10 microns and total areas as large as several cm². Such devices, may be compatible with biological tissue.

Arrangements may provide all-organic lasing, for example by use of fluorescent doped silk, nanostructured in the form of a designed photonic material to have nanoscale features, and to exploit resultant random lasing properties of such a material.

A silk random laser provides a route to combine form (disordered structure of the material) and function (lasing emission) in one biocompatible system.

In some arrangements, a laser dye (Rhodamine 6G and/or other dyes) doped silk solution comprises a constituent material from which an appropriate structure is formed. Such a solution may be used to spin-coat thin films on glass. The feasibility of dye integration in silk has been proven in fluorescence experiments [9]

The optical gain of dye molecules when self-assembled within the silk beta-sheets may support operation of a random laser detector. Such a silk molecular scaffold may provide an ideal structure to prevent inter-Rhodamine quenching, increasing the optical gain and protecting dye molecules by dissipating extra heat and excitation.

Construction methods allow for the measurement and optimisation of optical gain length of the constructed new organic materials by exploiting a strip-length technique [11]. Maximising optical gain can be beneficial to detectors, since it may decrease the random lasing threshold, thus making a final device more efficient.

One limitation of any random lasing system is the optical gain that can be added to the system. In particular, in a biocompatible system it may be necessary to resort to organic dyes that have a gain coefficient 100-1000 times smaller compared to that of ordinary crystalline semiconductor quantum wells. Arrangements recognise that (i) molecular and (ii) plasmon enhancement may provide a solution to this problem.

Molecular enhancement: arrangements recognise that if dye is inserted into an appropriate molecular scaffolding, as in silk beta-sheets, associated optical properties may be enhanced, as has been shown for dye-doped DNA strands [11]. In some arrangements, a large proportion of the dye molecules will fill the inner part of the beta-sheets due to charge interaction. Such filling may prevent homo-FRET and proximity quenching and will allow for a higher gain as well as a higher dye concentration.

Plasm onic enhancem ent: arrangements recognise that near-field plasmon enhancement around plasmonic resonators may be explored to provide a novel strategy to increase and control stimulated emission by exploiting plasmon waves [12, 13, 14], localised at the surface of small metallic particles, which can be easily inserted into silk [8]. While plasmonic enhancement is widely used to control and enhance light fluorescence [15] the role of localised plasmon resonances for lasing and random lasing is still a largely unexplored field and is expected to lead to a new class of random lasing with much lower threshold and higher efficiency.

Experimental techniques: arrangements may test molecular integration by: fluorescence dynamics (decay rate) and confocal time-correlated photon counting microscopy [16]; and gain measured by stripe length techniques [11].

Silk Photonic Glass

Arrangements may provide a self-assembled all-silk inverted photonic glass. That photonic glass comprises a random disordered structured material comprising air voids in a silk matrix, following a known construction technique [17], which has already been applied in the context of silk inverse photonic crystals [18]. Arrangements may be fabricated by, for example, (i) silk casting in a photonic glass made of polystyrene spheres; or (ii) direct assembly of a solution of water, silk and polystyrene spheres. In both cases, the spheres are typically removed after assembly by washing in toluene, which does not affect the silk. Arrangements may provide that dye molecules are added to the silk before assembling a photonic glass.

In some arrangements, a system can be further engineered to enhance its scattering and amplification [11] properties by doping it with gold nanoparticles (˜50 nm diameter) supporting plasmonic resonances [8]. In some arrangements it is possible to cast a silk photonic glass of complex external shape by using a ₃D printed mould.

Experimental techniques: silk photonic glass in accordance with some arrangements can be grown by methods of wet, room temperature self-assembly and characterised by the measurement of their optical transport properties such as the scattering mean free path in accordance with known techniques [19]. The material topology can also be assessed by secondary electron microscopy (SEM).

Other Materials and Methods

Similar methods to those described above in relation to a silk photonic glass may be used to create gain medium materials from other proteins, polysaccharides and colloids of nanocrystal. Alternative methods to create appropriate gain medium materials include use of an emulsion. In particular, for example, it is possible to form appropriate scattering features in a material by forming an emulsion or by creating, for example, a foam. It is, for example, possible to achieve lasing from a polysaccharide foam. Such a foam may be formed from, for example, chitosan or pectin. The scattering features of such a foam, for example, may comprise pores or “bubbles”. Those pores or bubbles may be of various sizes. It will be appreciated that, if the gain medium is formed as an emulsion or foam, rather than adding spheres in manufacture, as in the case of a silk photonic glass, scattering features take the form of bubbles or voids.

Random Lasing

Methods described above can be used to identify an appropriate detector gain medium structure and random lasing can be tested by pump and probe lasing spectroscopy. Random lasing action can be triggered by optical excitation with, for example, an energetic ns-pulsed laser. Tests can be designed to record the lasing action upon single-pulse excitation. Arrangements recognise that lasing wavelength and lasing threshold may change with the material parameters such as, for example,: templating sphere size, laser dye type and amount, crosslinked state of silk. Arrangements may optimise material architecture for minimal threshold random lasing. Some arrangements may include plasmonic nano-resonators (gold nano-spheres) within the structure to provide random lasing. Provision of such plasmonic nano-resonators may increase the scattering but also decrease the gain because of their ohmic losses.

Sensing by Lasing

Once a suitable structure for a particular application is characterised, silk random lasing material may be utilised as a novel biosensor. Gain media suited to such a detecting application may be provided, according to some arrangements, by replacing the laser dye with a sensing dye whose optical properties change in presence of a target compound or target biological activity. In accordance with some arrangements, various solutions of silk and dyes, are first tested with fluorescence dynamics and gain studies and then in silk random lasing devices.

Some arrangements focus on sensing hydrogen peroxide (H₂O₂), a reactive oxygen species. An imbalance in the levels of reactive oxygen species leads to a state of oxidative stress within the body. The overproduction of H₂O₂ is related to ageing and neurodegenerative diseases such as Alzheimer's and Parkinson's, but its presence is also beneficial to cell fitness, for example, for cell signalling or as a defence against microbial invasions [20]. Even with an increased interest in the study of oxidative stress, there are still a limited number of methods available for the detection of H₂O₂ produced from cells [21].

At the heart of the sensing process of arrangements is selection of a dye with appropriate target sensitivity. In arrangements to sense hydrogen peroxide, a suitable target-sensitive dye may comprise a dye whose properties change upon oxidation. Such dyes may comprise, for example, Dihydrorhodamine, Peroxy, DCFH and/or Amplex Red.

The sensing mechanism employed by a target detector according to arrangements is as follows: a target molecule diffuses inside a gain medium, for example, a porous silk scaffold. The target molecule binds to the target sensitive material, in this arrangement, the sensing dye whose (i) optical gain, (ii) excited state lifetime or (iii) quantum efficiency are altered. For example, Amplex Red is a blue dye, weakly fluorescent until it reacts with H₂O₂. After reaction it is reduced to highly red fluorescent resorufin. This optical change is expected to bring the random lasing in or out of operation in some arrangements by changing the lasing threshold energy of a gain medium. Whist monitoring using a fluorescent sensor would give a signal which was linear in response to a percentage of H₂O₂, a lasing sensor response is exponential, and therefore much more sensitive and can be distinguished above typical background noise. Use of a random lasing sensor in accordance with arrangements may provide a large lasing threshold change, lasing switching (on/off) and/or a large spectral shift when a target permeates the gain medium. Arrangements may not suffer the limitations encountered in relation to fluorescence sensing, i.e. the auto-fluorescent background, and may allow for creation of a clear report on the presence of H₂O₂.

Experimental techniques: testing the random lasing when exposed to a solution containing H₂O₂ at various concentrations can be used to calibrate or validate a constructed biosensing device.

Detector gain media in accordance with aspects, embodiments and arrangements may have lasing properties which can advance understanding of a physical process underlying stimulated emission in protein-based polymers as well as the molecular and optical properties of dye encapsulated in silk beta-sheet. Bio- and soft-matter pose new challenges to optical and lasing devices, which can be addressed by some arrangements. Some arrangements provide random lasing to be used as a novel light source which has potential to provide inside-tissue and speckle-free illumination.

Some arrangements may provide a material to be integrated in biological tissues for bioengineering applications with the potential to provide a new tool to image and sense biological properties inside human body.

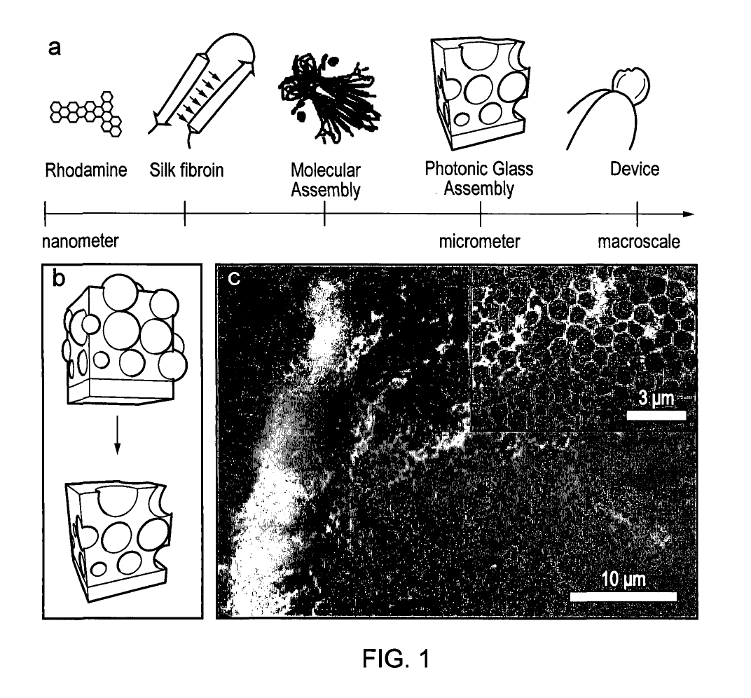

FIGS. 1a to 1c illustrate schematically one possible fabrication process of an inverse silk photonic glass arrangement.

FIG. 1b shows hierarchical integration of material from nanoscale to macroscale in accordance with one arrangement. As shown in FIG. 1a: rhodamine molecules are inserted in silk fibroin which are, in turn, assembled and nanostructured into an inverse photonic glass and into a macroscopic random lasing device.

FIG. 1b illustrates a sketch of a direct and inverse structure according to one arrangement. A direct photonic glass of polystyrene sphere and silk is obtained by self-assembly followed by silk crystallisation. Liquid silk destabilises a colloidal solution such that flocculation occurs and a disordered assembly is naturally formed. The inverse photonic glass is then obtained by selective etching of polymer spheres. FIG. 1c is a panoramic SEM image of the final structure, including a zoom image in the inset. The spherical silk shells and the connected holes are visible.

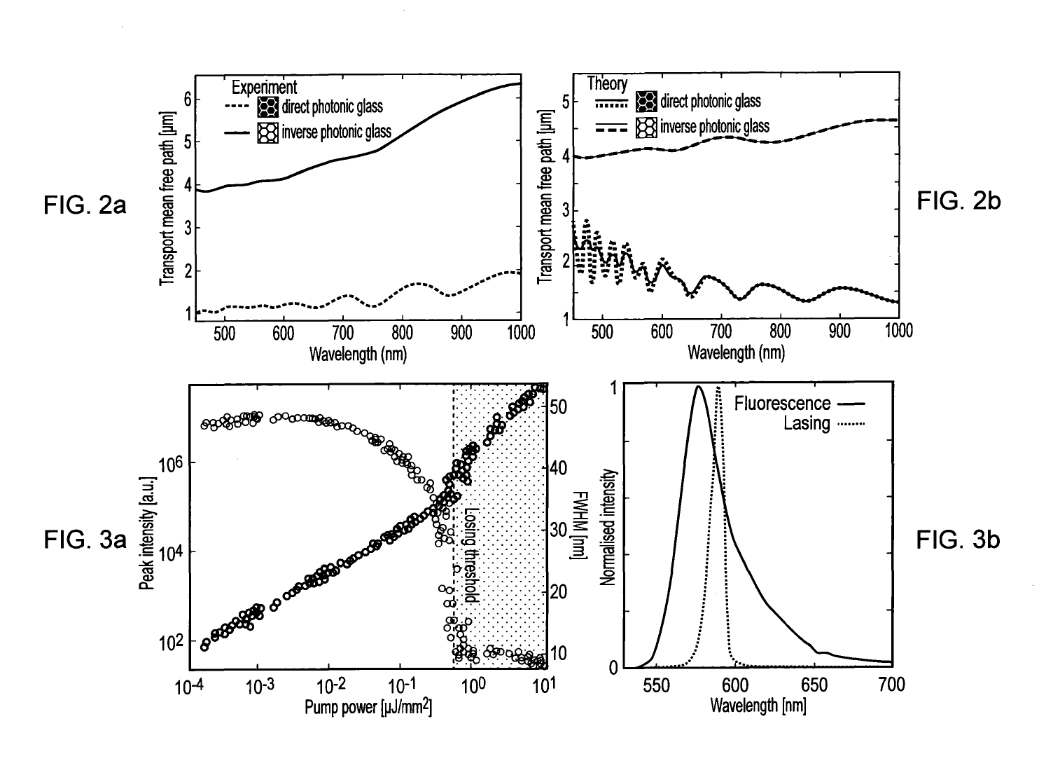

FIG. 2 illustrates graphically light transport in a silk photonic glass such as that shown in FIG. 1c. FIG. 2a shows graphically measurements of a direct and inverse photonic glass light transport mean free path. The total integrated transmission is measured with an integrating sphere, upon white light illumination. For samples of different thicknesses; the transport mean free path is obtained by fitting the data to the photonic Ohm's law. Clear resonances are visible for the direct photonic glass. The inverse structure made of air voids has rather a flat response over the visible range, as may be expected for such low quality Mie resonators.

FIG. 2b shows graphically a theoretical transport mean free path calculated for both direct and inverse geometries. The predicted curves are obtained from Mie theory and independent scattering approximation. Dashed lines represent: (red) polystyrene spheres with diameter d=1280 nm and refractive index n_ps=1.6 at filling fraction f=0.5 and dashed lines (blue) represent an inverse structure composed of air voids in silk, n_silk=1.6. The solid lines are the same curves once the effect of the spheres size polydispersity (˜2%) is taken into account.

FIG. 3 illustrates graphically properties of silk random lasing. FIG. 3a comprises a characteristic plot of random lasing which shows peak power (blue circles) and emission linewidth (green circles). For increasing pump intensity around the lasing threshold (in this case, 70 μJ/mm2 of pump energy) the peak power presents an abrupt increase and a change of slope, while the linewidth suddenly collapses from 48 to 8 nm. FIG. 3b illustrates emission spectra of a silk inverted photonic glass both below (cyan line, for P=40 μJ/mm2) and above (red line, for P=1000 μJ/mm2) the lasing threshold. The fluorescence intensity peak is at 578 nm, while lasing occurs at 589 nm; and a clear change in the emission linewidth is visible.

A structure formed to act as a detector can be used as a sensor since random lasing may change state (on/off) and/or spectral emission in dependence upon the targeted biological activity. Such a structure therefore becomes a sensing laser. Sensing lasers may have applications in relation to in-vivo sensing of biological activity. Appropriately constructed gain media may be inserted in humans and, after use, may biodegrade and be processed by the human body leaving no trace. Appropriately constructed gain media may be applied to human skin, inserted in bones, or any tissue external and internal.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

### REFERENCES

[1] X. Fan & S.-H. Yun The potential of optofluidic biolasers, Nature Methods 11, 141.-147 (2014).

[2] C. Vannahme et al. Single-mode biological distributed feedback laser, Lab Chip 13, 2675-2678 (2013).

[3] M. C. Gather and S. H. Yun, Single-Cell biological lasers, Nat. Photonics, 5, 406-410 (2011).

[4] D. Wiersma, The physics and applications of random lasers, Nat. Physics 4, 359-367 (2008) doi:10.1038/nphys971.

[5] S. Gottardo, R. Sapienza et al. Resonance-driven random laser Nat. Photonics 7, 102 (2008).

[6] S. Nizamoglu, M. C. Gather, and S. Hyun Yun, All-Biomaterial Laser using Vitamin and Biopolymers, Adv. Matter. 25, 5988 (2013).

[7] Hu Tao, D. L. Kaplan, F. G. Omenetto, Silk Materials—A Road to Sustainable High Technology. Adv. Matter. 24, 2824-2837 (2012).

[8] Hu Tao, et al, “Gold Nanoparticle-Doped Biocompatible Silk Films as a Path to Implantable Thermal-electrically Wireless Powering Devices,” App. Phys. Lett., 97 12, 123702 (2010).

[9] N. C. Tansil, et al. Intrinsically Colored and Luminescent Silk. Adv. Mater. 23, 1463-1466 (2011).

[10] S. Toffanin, et al. Low-threshold blue lasing from silk fibroin thin films. Appl. Phys. Lett. 10 1, 091110 (2012).

[11] M. Leonetti, R. Sapienza, et al. Optical gain in DNA-DCM for lasing in photonic materials Optics Letters 34, 3764-3766 (2009).

[12] M. A. Noginov, et al. Demonstration of a spaser-based nanolaser, Nature 460 1110 (2009). doi:10.1038/nature08318

[13] O. Hess, et al. Active nanoplasmonic metamaterials, Nat. Materials, 11 573 (2012).

[14] X. Meng, et al Plasmonically Controlled Lasing Resonance with Metallic—Dielectric Core—Shell Nanoparticles. Nano Lett. 11, 1374-1378 (2011).

[15] M. Castro-Lopez D. Brinks, Riccardo Sapienza, and N. F. van Hulst, Aluminum for Nonlinear Plasmonics: Resonance-Driven Polarized Luminescence of Al, Ag, and Au Nanoantennas, Nanoletters 11 4674-4678 (2011).

[16] R. Sapienza, et al., Long-tail statistics of Purcell factor in disordered media driven by near-field interactions, Phys. Rev. Lett. 10 6, 163902 (2011).

[17] P. D. Garcia, R. Sapienza, et al. Photonic Glass: A Novel Random Material for Light. Adv. Matter. 19, 2597-2602 (2007).

[18] S. Kim, et al. Silk inverse opals. Nat. Photonics 6 1-6 (2012).

[19] R. Sapienza, et al. Observation of Resonant Behavior in the Energy Velocity of Diffused Light,Phys. Rev. Lett. 99, 233902 (2007).

[20] S. G. Rhee, H2O2, a necessary evil for cell signaling. Science 312, 1882-1883 (2006).

[21] Hong Jin, et al., Detection of single-molecule H2O2 signalling from epidermal growth factor receptor using fluorescent single-walled carbon nanotubes, Nature Nanotechnology 5, 302-309 (2010).

1. A target detector comprising:
a structure comprising: a gain medium comprising a plurality of disordered scattering nanostructure features and a target-sensitive material; said structure being configured, when pumped, to support random lasing and to exhibit a change in the gain of said gain medium and said random lasing in response to a change in said target.

2. A target detector according to claim 1, wherein said structure comprises: a substantially porous structure.

3. A target detector according to claim 1, wherein said structure comprises: a biocompatible gain material.

4. A target detector according to claim 1, wherein said gain medium comprises: a matrix structure and said target sensitive material is dispersed within said matrix.

5. A target detector according to claim 1, wherein said gain medium structure comprises: a polymeric material said target sensitive material is dispersed within said polymeric material.

6. A target detector according to claim 1, wherein said gain medium comprises: a protein; a polysaccharide; a colloid or a nanocrystal.

7. A target detector according to claim 1, wherein said gain medium comprises: at least one of: silk or cellulose.

8. A target detector according to claim 1, wherein said nanostructure features comprise: substantially spherical volumes having a different refractive index to material surrounding those substantially spherical volumes.

9. A target detector according to claim 1, wherein said nanostructure features comprise: volumes formed between neighboring substantially spherical volumes of a material, said volumes having a different refractive index to said material.

10. A target detector according to claim 1, wherein said target-sensitive material comprises: a material configured to have a variation in net optical gain in the presence of said target.

11. A target detector according to claim 1, wherein said target-sensitive material comprises a dye molecule configured to bind with said target.

12. A target detector according to claim 1, wherein the target detector comprises: a structure having a minimum bulk dimension selected to maintain a minimum scattering path length.

13. A target detector according to claim 12, wherein the target detector comprises: a structure having bulk dimensions of between 10 to 100 micrometres.

14. A method of detecting a target comprising:
providing a structure comprising: a gain medium comprising a plurality of disordered scattering nanostructure features and a target sensitive material;
configuring said structure such that, when pumped, random lasing is supported and such that a change in the gain of said gain medium and said random lasing is exhibited in response to a change in said target.

15. A target monitoring apparatus comprising:
a random laser pump, configured to pump a target detector, wherein the target detector comprises a gain medium comprising a plurality of disordered scattering nanostructure features and a target-sensitive material; and
a probe configured to monitor response of said target detector to said pumping.

16. The target monitoring apparatus according to claim 15, wherein said probe is configured to monitor at least one of: wavelength response or energy response of said target detector to said pumping.

17. The target monitoring apparatus according to claim claim 16, wherein said pumping radiation has an energy selected to prevent damage to biological tissue.

18. (canceled)
